(19) United States
(12) Patent Application Publication
(10) Pub. No.: US 2005/0084581 A1
(43) Pub. Date: Apr. 21, 2005

(54) Apparatus for liquid food sterilization or enzyme deactivation with supercritical carbon dioxide, and method of liquid food sterilization or enzyme deactivation, and liquid food obtained by the use of the apparatus and the method

(76) Inventor: Yoshiyuki Sato, Yamanashiken (JP)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/686,570

(22) Filed: Oct. 17, 2003

(51) Int. Cl. A23C 1/00

(52) U.S. Cl. 426/521

(57) ABSTRACT

In a method of sterilization or enzyme inactivation for a liquid food with supercritical carbon dioxide, used is a sterilization apparatus not requiring any large-size pressure tanks for contact of the liquid food with carbon dioxide therein. The apparatus comprises (A) a high-performance pressure mixer for mixing the liquid food and carbon dioxide therein, (B) an accumulator (pressure pipe) and (C) a pressure-resistant carbon dioxide releaser that are so planned as to be resistant to a pressure not lower than the critical pressure of carbon dioxide and are connected in series in that order, in which the inner temperature of the high-performance pressure mixer and the accumulator is kept all the time not lower than the critical temperature of carbon dioxide.

### BACKGROUND OF THE INVENTION

1. Field of the Invention

The present invention relates to an apparatus for liquid food sterilization or enzyme deactivation with supercritical carbon dioxide, not requiring a large-size pressure tank for contact of a liquid food with carbon dioxide therein (by dissolving supercritical carbon dioxide in a liquid food), to a method of liquid food sterilization or enzyme deactivation, and to the liquid food obtained by the use of the apparatus and the method.

More precisely, the invention relates to an apparatus for liquid food sterilization or enzyme deactivation with supercritical carbon dioxide, in which a liquid food pressurized to a pressure not lower than the critical pressure of carbon dioxide is contacted with carbon dioxide pressurized to a pressure not lower than the critical pressure thereof in a high-performance pressure mixer and an accumulator and kept therein for a predetermined period of time, and thereafter it is degassed in a carbon dioxide releaser (carbon dioxide is removed from it) to thereby kill the microorganisms in the liquid food or deactivate the enzyme therein; and relates to a method of liquid food sterilization or enzyme deactivation (this may be hereinafter simply referred to as “sterilization method”), and to the liquid food obtained by the use of the apparatus and the method.

2. Description of the Related Art

The following patent publication are known, relating to an apparatus and a method for killing microorganisms in a liquid food (e.g., fresh juices, alcoholic drinks, seasonings) or deactivating enzyme therein.
(a) JP 3,042,830,
(b) JP-A 2000-139433,
(c) JP-A 2002-78478.

These publications describe, as a means of contacting a liquid food to be sterilized with supercritical carbon dioxide (dissolving carbon dioxide in a liquid food), a method and an apparatus of introducing micro-bubbles of carbon dioxide into a liquid food in a pressure tank at a temperature lower than the critical temperature of carbon dioxide to thereby dissolve the gas in the liquid food.

However, the sterilization apparatus and the sterilization method described in these publications have the following drawbacks:

(1) Almost all the above-mentioned, conventional sterilization apparatus and method require a large-size pressure tank (for gas dissolution in a liquid food therein). This is because, in these, carbon dioxide is formed into micro-bubbles thereof through a micro-filter in a pressure tank and then contacted with the liquid food (that is, dissolved in the liquid food).

However, the pressure tank requires resistance to high pressure of generally from 100 to 300 atmospheres (30 MPa), and large-size pressure tanks of the type are extremely difficult to construct from the technical and economical viewpoint for them.

As a result, test plants capable of processing the liquid food at a rate of 1 liter/hr can be constructed, but practicable plants larger than such test plants, for example, those capable of processing a large amount, for example, around 1000 liter/hr of liquid food are impossible to construct.

(2) Since the zone in which the liquid food is contacted with carbon dioxide is divided (separated) into a gas dissolution area (step), a soaking area (step) and a processing area (step) under critical condition, the apparatus for it is complicated. In addition, the different areas (steps) require different temperatures, and the driving operations for these are complicated.

Specifically, in the gas dissolution area (step) and in the soaking area (step), the liquid food to be processed is kept at a temperature (for example, 20° C.) not higher than the critical temperature of carbon dioxide (31.1° C.), and, in the processing area (step) under critical condition, it is kept at a temperature (for example, 45° C.) not lower than the critical temperature of carbon dioxide for a short period of time, for example, for 1 minute or so.

### SUMMARY OF THE INVENTION

To solve the above-mentioned drawbacks, we, the present inventors have developed a sterilization apparatus and a sterilization method for a liquid food which do not require a large-size tank in the step of contacting a liquid food with carbon dioxide therein and which, even though the contacting area (step) for the two therein is simplified, still ensure the sterilization effect thereof.

The present invention includes the following aspects:

(1) An apparatus for liquid food sterilization or enzyme inactivation with supercritical carbon dioxide, which comprises the following (A), (B) and (C) that are so planned as to be resistant to a pressure not lower than the critical pressure of carbon dioxide and are connected in series in that order and in which the inner temperature of (A) and (B) is kept not lower than the critical temperature of carbon dioxide:
(A) a high-performance pressure mixer for mixing a liquid food and carbon dioxide;
(B) an accumulator (pressure pipe);
(C) a pressure-resistant carbon dioxide releaser.

(2) The apparatus for liquid food sterilization or enzyme inactivation with supercritical carbon dioxide of above (1), wherein the liquid food is a fresh juice of orange, grape fruit, grape (Kyoho), peach or apple.

(3) A method for liquid food sterilization or enzyme inactivation with supercritical carbon dioxide, which comprises introducing a liquid food and carbon dioxide into the apparatus for liquid food sterilization or enzyme inactivation with supercritical carbon dioxide of above (1), under the following conditions (a) and (b), then keeping them therein and letting them out of it:
(a) the liquid food and carbon dioxide to be introduced into the high-performance pressure mixer are pressurized to a pressure not-lower than the critical pressure of carbon dioxide;
(b) the liquid food and carbon dioxide in the high-performance pressure mixer and the accumulator are all the time heated at a temperature not lower than the critical temperature of carbon dioxide.

(4) The method for liquid food sterilization or enzyme inactivation with supercritical carbon dioxide of above (3), wherein carbon dioxide is in a supercritical state.

(5) The method for liquid food sterilization or enzyme inactivation with supercritical carbon dioxide of above (3) or (4), wherein the staying and passing time of the liquid food and carbon dioxide in the apparatus is not shorter than 20 minutes.

(6) The method for liquid food sterilization or enzyme inactivation with supercritical carbon dioxide of above (3) to (5), wherein the ratio by weight of the liquid food to carbon dioxide to be introduced into the high-performance pressure mixer is from 70/30 to 30/70.

(7) The method for liquid food sterilization or enzyme inactivation with supercritical carbon dioxide of above (3) to (6), wherein the liquid food is a fresh juice of orange, grape fruit, grape (Kyoho), peach or apple.

(8) A liquid food obtained by the use of the apparatus for liquid food sterilization or enzyme inactivation with supercritical carbon dioxide of above (1) or (2).

(9) A liquid food obtained according to the method for liquid food sterilization or enzyme inactivation with supercritical carbon dioxide of above (3) to (7).

The reasons for the constitution of the invention as above are mentioned below.

(1) If a liquid food is desired to be fully contacted with carbon dioxide in a pressure tank, then it requires a large-size pressure tank. As a result, the apparatus for it is inevitably large-sized, but practicable large-sized apparatus are difficult to construct from the technical and economical viewpoint.

To solve the problem, in the present invention, the liquid food and carbon dioxide are contacted with each other only in a small-sized, high-performance pressure mixer and a pressure pipe connected to it. As compared with pressure tanks, the small-sized, high-performance pressure mixer and the pressure pipe are extremely easy to construct and are extremely easily available.

(2) For increasing the sterilization efficiency therein, the liquid food and carbon dioxide are kept all the time supercritically in the sterilization apparatus (not lower than the critical temperature 31.1° C., and not lower than the critical pressure 7.2 MPa).

For it, both the liquid food and carbon dioxide are previously pressurized and heated to the supercritical state of carbon dioxide, and the two are introduced into the high-performance mixer, stirred and mixed therein, and even after the resulting mixture is led into the pressure pipe, it is still (kept) heated and kept in the accumulator (pressure pipe) all the time under the supercritical state of carbon dioxide for a necessary period of time therein.

The staying and passing time of the fluid in and through the accumulator may be readily controlled by varying the length of the accumulator and the flow rate of the fluid through it.

(3) The critical temperature of carbon dioxide is 31.1° C. and is relatively low. Therefore, even when the liquid food is kept at the critical temperature or higher, or that is, under the supercritical state of carbon dioxide, its quality is deteriorated little.

The liquid food to be sterilized in the invention is a food that is liquid at 0° C. or higher, including, for example, fruit juices, vegetable juices, seasonings, raw alcoholic drinks, beer, etc.

The microorganisms in liquid food that are to be killed in the invention are bacteria, yeasts, fungi, etc.; and the enzyme therein to be inactivated is essentially pectinase, amylase, protease, lipase, carboxypeptidase, etc.

Not limited in point of its type and shape, the high-performance pressure mixer for use in the invention may be any one of good pressure resistance (durability) to the supercritical pressure of carbon dioxide enough to ensure high-speed mixing of the liquid food and carbon dioxide (with good stirring efficiency).

Also not limited in point of its material, the accumulator (pressure pipe) for use in the invention may be any one of good pressure resistance (durability) to the supercritical pressure of carbon dioxide not interference with food hygiene.

Concretely, herein usable are pipes of metal or plastics of pressure resistance.

In the invention, the ratio by weight of the liquid food to carbon dioxide to be introduced into the pressure mixer preferably is from 70/30 to 30/70.

If the ratio of carbon dioxide to the liquid food is smaller than the range, the sterilization effect of the invention may significantly reduce; but if larger than the range, it is impracticable since the amount of the liquid food that is sterilizable in the invention may significantly lower.

### BRIEF DESCRIPTION OF THE DRAWINGS

FIG. 1 is a basic constitution view of the sterilization apparatus for the liquid food of the invention.

FIG. 2 is a view showing one example of the sterilization apparatus for the liquid food.

FIG. 3 is a cross-sectional view showing one example of the high-performance pressure mixer for use in the invention.

FIG. 4 is a cross-sectional view showing one example of the degassing device for use in the invention.

### DESCRIPTION OF THE PREFERRED EMBODIMENTS

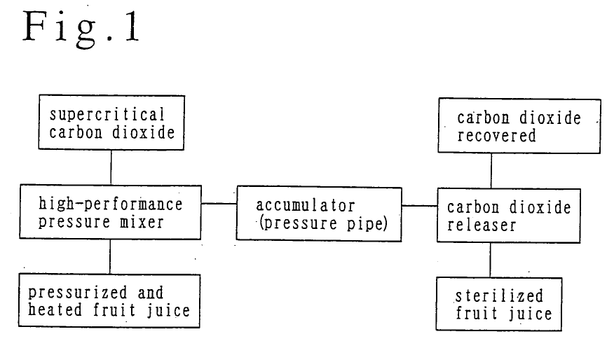

Embodiments of the sterilization apparatus for the liquid food (fruit juice) of the invention are described with reference to the drawings attached hereto. The basic constitution of the apparatus is as in FIG. 1. It comprises a high-performance pressure mixer 1, an accumulator (a pressure pipe for keeping critical state) 2, and a carbon dioxide releaser 3 connected in that order.

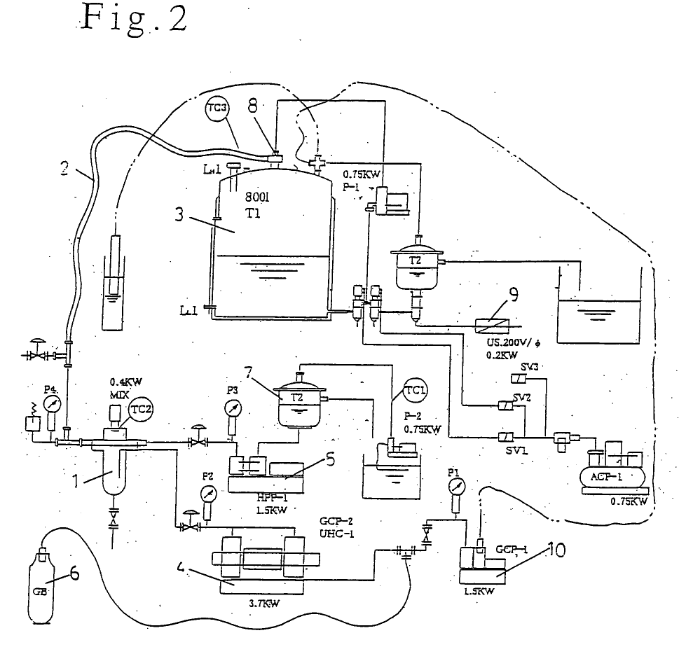

FIG. 2 shows one example of the sterilization apparatus of the invention for practical use.

The high-performance pressure mixer 1 is connected to a carbon dioxide cylinder 6 via a compressor 4 for increasing the pressure of carbon dioxide. A liquid food tank 7 is connected to the high-performance pressure mixer 1 via a pump 5 for pressurizing the liquid food. The liquid food and carbon dioxide to be introduced into the high-performance pressure mixer 1 are previously pressurized and heated separately by the compressor 4 and the pump 5, respectively. The degree of pressure to which they are pressurized is at least the critical pressure of carbon dioxide or more. In general, it is 10 MPa (100 atmospheres) or so. The degree of heat to which they are heated is at least the critical temperature of carbon dioxide (31.1° C.), generally 40° C. or so. The carbon dioxide releaser 3 is a stainless degassing tank, and it is connected to the accumulator 2 via a degassing device (valve) 8. The accumulator 2 is a stainless or pressure-resistant plastic pipe (for example, formed of Teflon®). A heater and a heat-resistant material surround the accumulator 2 to keep it heated. Thus constructed, the inner temperature of the accumulator 2 is all the time kept not lower than the critical temperature of carbon dioxide.

One example of the high-performance pressure mixer 1 is shown in FIG. 3.

This comprises an inlet 11 for supercritical carbon dioxide, an inlet 12 for pressurized heated fruit juice, and an outlet 13 for a mixture of the liquid food and the supercritical carbon dioxide. In this, the stirring propeller 14 is variable within a range of from 100 to 1000 rpm. The pressure mixer body 15 and the pressure cover 16 are both resistant to pressure, and a cleaning exhaust valve 17 is provided at the bottom of the body.

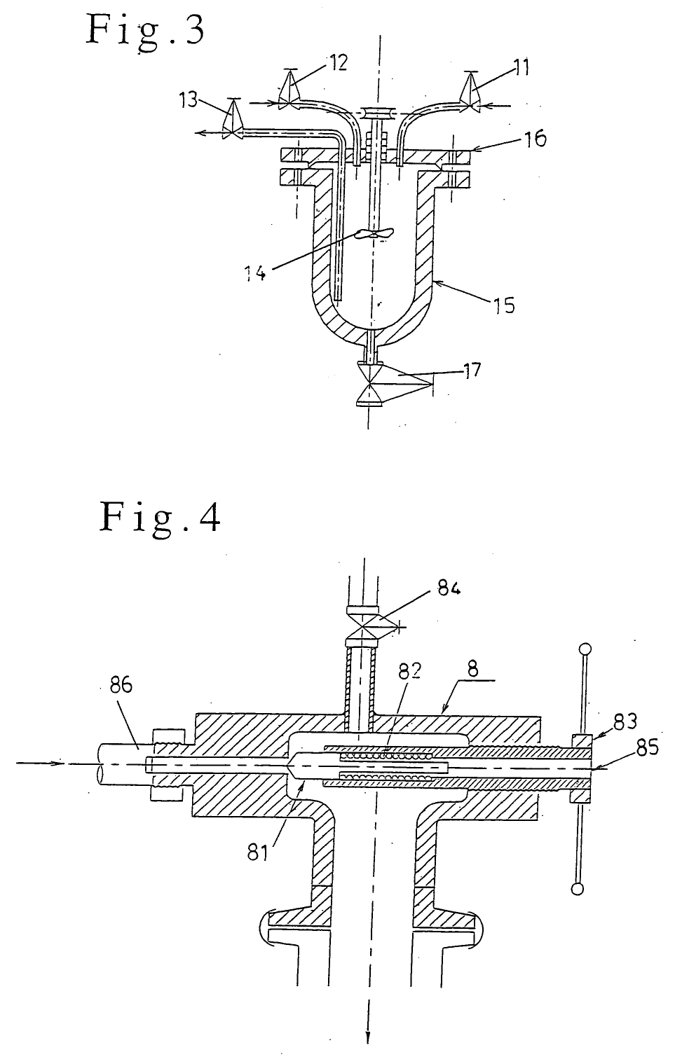

One example of the degassing device 8 of the carbon dioxide releaser 3 is shown in FIG. 4.

The degassing device 8 comprises a valve body 81, a valve pressing spring 82, and a pressure-controlling rod 83 for the valve pressing spring 82. A heating liquid circulation valve 84 is connected to the top of the device 8, and a cleaning hole 85 is formed at the center of the pressure-controlling rod 83. The liquid food having passed through the accumulator 3 enters the degassing device 8 from the side of the high-pressure mixture inlet joint 86, and is subjected to vapor-liquid (carbon dioxide-fruit juice) separation in the carbon dioxide releaser 3. Thus separated, the fresh juice is degassed to atmospheric pressure.

The thus-separated, sterilized fruit juice may be exposed to ultrasonic waves in an ultrasonic oscillator 9 to thereby further completely remove carbon dioxide from it.

Carbon dioxide is recovered in the compressor 10 and recycled.

### EXAMPLE

Using the sterilization device of FIG. 2 (mixer capacity 2 liters; inner diameter of accumulator 100 mm; length of accumulator 12 m; releaser capacity 400 liters), fresh juices of orange, grape fruit, grape (Kyoho) and apple were processed under the condition mentioned below to determine the sterilization effect and the pectinase activity change thereof.
(1) Amount of juice tested: 300 liters
(2) Temperature of juice introduced into mixer: 40° C.
(3) Mixer revolution: 400 or 800 rpm
(4) Ratio by weight of juice to carbon dioxide introduced into mixer: 60/40
(5) Residence time in accumulator: 40 min
(6) Inner pressure of mixer and accumulator: 100 kg/cm²
(7) Flow rate: 180 liters/hr
(8) Determination of pectinase: 5 ml of each juice is added to 20 ml of 1% pectin (of lemon), and its pH is adjusted to 7.5 by the use of a pH meter. Next, this is stirred in a thermostat at 30° C. for 30 minutes, and then titered to pH of 7.5 with 0.01 N sodium hydroxide, and the amount of titration is read. The pectinase activity of the processed juice is expressed as the relative value to the titration, 100% of the non-processed juice.

The test data of the sterilization effect and those of the pectinase activity change are shown in Table 1.

TABLE 1

| | | Number of | | |
|---|---|---|---|---|
| | Mixer | Living | Number of | Pectinase |
| | Revo- | Microbe | Yeast | Activity |
| | lution | Cells, | Cells, | Change |
| | (rpm) | CFU/ml | CFU/ml | (%) |
| Non-processed Orange | — | 3.5 × 10³ | 4.8 × 10³ | 100 |
| Processed Orange | 400 | 2.3 × 10² | 2.1 × 10² | 11 |
| Non-processed Orange | — | 3.1 × 10³ | 3.5 × 10⁴ | — |
| Processed Orange | 800 | 30> | 4.0 × 10 | — |
| Non-processed Orange | — | 1.5 × 10⁴ | 5.0 × 10⁴ | — |
| Processed Orange | 800 | 30> | 30> | — |
| Non-processed Grape Fruit | — | 1.0 × 10² | 8.0 × 10 | 100 |
| Processed Grape Fruit | 400 | 30> | 30> | 9 |
| Non-processed Grape Fruit | — | 1.1 × 10⁴ | 1.5 × 10⁴ | — |
| Processed Grape Fruit | 800 | 30> | 30> | — |
| Non-processed Grape Fruit | — | 5.9 × 10³ | 6.2 × 10³ | — |
| Processed Grape Fruit | 800 | 30> | 30> | — |
| Non-processed Grape | — | 1.3 × 10² | 8.0 × 10 | 100 |
| (Kyoho) | | | | |
| Processed Grape (Kyoho) | 400 | 30> | 30> | 0 |
| Non-processed Apple | — | 7.0 × 10 | 3.9 × 10 | 100 |
| Processed Apple | 400 | 30> | 30> | 34 |

From Table 1, it is understood that the microorganisms decreased in all the processed juices and the pectinase was deactivated in most of the processed juices.

The advantages of the invention are mentioned below.

(1) The apparatus and the method of the invention for liquid food sterilization or enzyme deactivation with supercritical carbon dioxide are advantageous in that they do not require a large-size pressure tank for contact of the liquid food and carbon dioxide. Therefore, the capacity of the apparatus of the invention may be readily increased (or that is, the processing capability of the apparatus can be readily increased), and the invention enables practical use of supercritical carbon dioxide sterilization for processing the liquid food. Thus processed by the use of the apparatus and the method of the invention, the liquid food is well sterilized and the enzyme therein is well deactivated.

(2) In the apparatus of the invention, the zone in which the liquid food is contacted with carbon dioxide is not divided (separated) into a gas dissolution area (step), a soaking area (step) and a processing area (step) under critical condition, and therefore the apparatus is simple. In addition, the temperature control in the apparatus is only for keeping the system not lower than the critical temperature of carbon dioxide. Therefore, the apparatus can be driven in a simplified manner.

(3) As a result, in the liquid food processed in the invention, heat-sensitive substances are not degraded and may remain as they are. A large amount of such processed liquid food may be obtained at low costs in the invention.

1. An apparatus for liquid food sterilization or enzyme inactivation with supercritical carbon dioxide, which comprises the following (A), (B) and (C) that are so planned as to be resistant to a pressure not lower than the critical pressure of carbon dioxide and are connected in series in that order and in which the inner temperature of (A) and (B) is kept not lower than the critical temperature of carbon dioxide:
(A) a high-performance pressure mixer for mixing a liquid food and carbon dioxide;
(B) an accumulator (a pressure pipe);
(C) a pressure-resistant carbon dioxide releaser.

2. The apparatus for liquid food sterilization or enzyme inactivation with supercritical carbon dioxide as claimed in claim 1, wherein the liquid food is a fresh juice of orange, grape fruit, grape (Kyoho), peach or apple.

3. A method for liquid food sterilization or enzyme inactivation with supercritical carbon dioxide, which comprises introducing a liquid good and carbon dioxide into the apparatus for liquid food sterilization or enzyme inactivation with supercritical carbon dioxide of claim 1, under the following conditions (a) and (b), then keeping them therein and letting them out of it:
(a) the liquid food and carbon dioxide to be introduced into the high-performance pressure mixer are pressurized to a pressure not lower than the critical pressure of carbon dioxide;
(b) the liquid food and carbon dioxide in the high-performance pressure mixer and the accumulator are all the time heated at a temperature not lower than the critical temperature of carbon dioxide.

4. The method for liquid food sterilization or enzyme inactivation with supercritical carbon dioxide as claimed in claim 3, wherein carbon dioxide is in a supercritical state.

5. The method for liquid food sterilization or enzyme inactivation with supercritical carbon dioxide as claimed in claim 3, wherein the staying and passing time of the liquid food and carbon dioxide in the apparatus is not shorter than 20 minutes.

6. The method for liquid food sterilization or enzyme inactivation with supercritical carbon dioxide as claimed in claim 3, wherein the ratio by weight of the liquid food to carbon dioxide to be introduced into the high-performance pressure mixer is from 70/30 to 30/70.

7. The method for liquid food sterilization or enzyme inactivation with supercritical carbon dioxide as claimed in claim 3, wherein the liquid food is a fresh juice of orange, grape fruit, grape (Kyoho), peach or apple.

8. A liquid food obtained by the use of the apparatus for liquid food sterilization or enzyme inactivation with supercritical carbon dioxide of claim 1.

9. A liquid food obtained according to the method for liquid food sterilization or enzyme inactivation with supercritical carbon dioxide of claim 3.
